(19) United States
(12) Patent Application Publication
(10) Pub. No.: US 2004/0149030 A1
(43) Pub. Date: Aug. 5, 2004

(54) Device for determining and/or monitoring filling of a medium in a container

(76) Inventor: Clemens Heilig, Offenburg (DE)

Correspondence Address: Felix J D'Ambrosio, Jones Tullar & Cooper, Eads Station, P O Box 2266, Arlington, VA, 22202, US

(21) Appl. No.: 10/481,403

(22) PCT Filed: Jun. 19, 2002
(86) PCT No.: PCT/EP02/06750

(30) Foreign Application Priority Data
Jun. 27, 2001 (DE) 101-31-081.1

(51) Int. Cl. G01F 23/22

(52) U.S. Cl. 73/290 V

(57) ABSTRACT

The invention relates to an economical device for reliably determining and/or monitoring filling of a medium in a container. Said device comprises the following components: a housing (20) to which at least one oscillating unit (3) is affixed; a drive/receive unit (4; 13, 14) that is directly fixed to the oscillating unit (3) and that causes it to oscillate at given time interval in at least one of its own modes, in addition to a regulation/evaluation unit (8) that recognizes when a predetermined filling level has been reached based on the detected oscillations or a time change in the detected oscillation of the oscillating unit (3) and/or recognizes a disturbance caused by the sensor and/or the process on the basis of the detected oscillations or a change in the detected oscillations.

The invention relates to a device for determining and/or monitoring the level of a medium in a container.

U.S. Pat. No. 4,540,981 has disclosed a method and a device for detecting the level of a liquid medium. The device has a rod-like structure which projects into a container in which the liquid medium is stored. The rod-like structure is fixed to one side of the diaphragm. The system comprising the diaphragm and rod-like structure is excited into inherent vibrations via a piezoelectric converter which is arranged on the other side of the diaphragm. The decay response of the vibrations is used to detect whether the system is vibrating freely or whether it is contact with the liquid.

One drawback with the known solution can be seen in the fact that the use of a diaphragm, on which the vibratory unit must be positioned in a very defined way, increases the production costs for the vibration detector. It is also disadvantageous that the eigen frequency of the known system comprising the diaphragm and vibratory unit reacts very sensitively to narrow-band interference from outside. For example, in the bulk goods sector, there are process-induced interference frequencies, such as those produced by conveyors belts and vibrators, preferably in the low-frequency range, in which the eigenfrequency of the vibratory system is normally also established. Since the influence of temporarily or continuously occurring interference variables cannot be distinguished from the current measured data indicating the level, there is the risk that faulty measured data are used to determine/monitor the level. As a result, the known device is not capable of supplying reliable information about the level of a medium in a container.

The invention is based on the object of proposing a cost-effective device for the reliable detection of the level of a medium in a container.

The object is achieved by a device which comprises the following components: a housing, to which at least one unit capable of vibrating (vibratory unit) is fixed; a drive/receiving unit which is fixed directly to the vibratory unit and excites it, at predefined time intervals, to vibrate in at least one of its inherent modes; a control/evaluation unit which uses the detected vibrations or the time change in the detected vibrations of the vibratory unit to detect that the predetermined level has been reached and/or which uses the detected vibrations or the change in the detected vibration to detect at least one sensor-induced and/or process-induced interference variable.

According to a preferred development of the device according to the invention, the vibratory unit is a rod or a tube. This rod or this tube is excited into inherent vibrations in at least one of its modes via the drive/receiving unit. The vibratory unit can consist, for example, of a metal (e.g. steel) or of a hard plastic like PPS or PEEK.

A preferred refinement of the device according to the invention provides for a springy element, which is connected to the vibratory unit in such a way that the latter is connected in a sprung manner to the housing or to a fixing part. The springy element may be, for example, a diaphragm. This diaphragm is used to decouple the tube or rod, vibrating in its inherent modes, from the fixing part or from the housing.

Alternatively or in addition, provision is made for the fixing part itself to be springy. This is achieved, for example, by means of notches which run radially and/or axially in the fixing part, so that the fixing part only has the thinnest possible outer sleeve. In physical terms, the springy fixing of the vibratory unit to the housing may be described as a spring-mass system, whose resonance frequency lies below the lowest eigenfrequency of the vibratory unit. The springy fixing therefore fulfils the function of an acoustic low-pass filter, which serves for the effective decoupling of the vibratory unit from the container.

A further possibility of decoupling the vibrating tube or the vibrating rod from the fixing part or the housing consists in the insertion of an intermediate piece made of a material whose acoustic input impedance differs considerably from the input impedance of the material of which the vibratory unit consists. If, for example, the tube or the rod is produced from metal, the inserted piece can consist of plastic.

An advantageous development of the device according to the invention proposes that the drive/receiving unit be at least one electromechanical converter. Use is preferably made of a piezoelectric converter.

This at least one drive/receiving unit is fixed to the vibratory unit in such a way that it cannot come into direct contact with the medium. To this end, the at least one drive/receiving unit is arranged in the interior of the vibratory tube. Alternatively, provision is made for the at least one drive/receiving unit to be fixed to the outer face of the vibratory unit. In any case, the drive/receiving unit should be separated from the process or from the medium by a diaphragm or a closing piece. Corresponding configurations are illustrated in detail in the drawings.

According to a first advantageous refinement of the device according to the invention, the control/evaluation unit excites the vibratory unit to vibrate continuously via a first electromechanical converter; a second electromechanical converter picks up the vibrations; the amplitude of or the amplitude change in the vibrations is used by the control/evaluation unit to detect that the predefined level has been reached.

Alternatively, provision is made for only one electromechanical converter to be used as the drive/receiving unit; the control/evaluation unit uses the input impedance of the coupled system comprising the vibratory unit and electromechanical converter to detect that a predefined level has been reached.

The control/evaluation unit preferably excites the vibratory unit to vibrate for a predefined time interval via the drive/receiving unit; the control/evaluation unit uses the decay behavior, especially the decay time of the vibrations of the vibratory unit or of the energy content of the decaying vibrations of the vibratory unit, or the time change in the vibration energy of the vibratory unit, to detect whether the vibratory unit is vibrating freely or is in contact with the filling material; in addition, the control/evaluation unit uses the decay response or the time change in the vibration energy to detect whether at least one sensor-induced and/or process-induced interference variable is occurring.

Furthermore, an advantageous development of the device according to the invention proposes that the control evaluation unit apply a periodic signal, a sweep signal or a noise signal to the drive/receiving unit.

It is particularly beneficial with regard to the detection of interference variables if the drive/receiving unit excites the vibratory unit to vibrate in at least two mutually different modes. By using the different vibration response in the at least two different modes, sensor-induced and/or process-induced interference variables can be detected, and can then be taken into account, if necessary, in determining or monitoring the level. In order to detect the formation of an attachment or other interference variables, use is made of the circumstance that higher-frequency and lower-frequency modes of interference variables of this type are attenuated to different extents.

According a very advantageous configuration of the device according to the invention, the entire signal generation, signal conditioning and signal processing is carried out by software by using a microprocessor.

The invention will be explained in detail using the following drawings, in which:

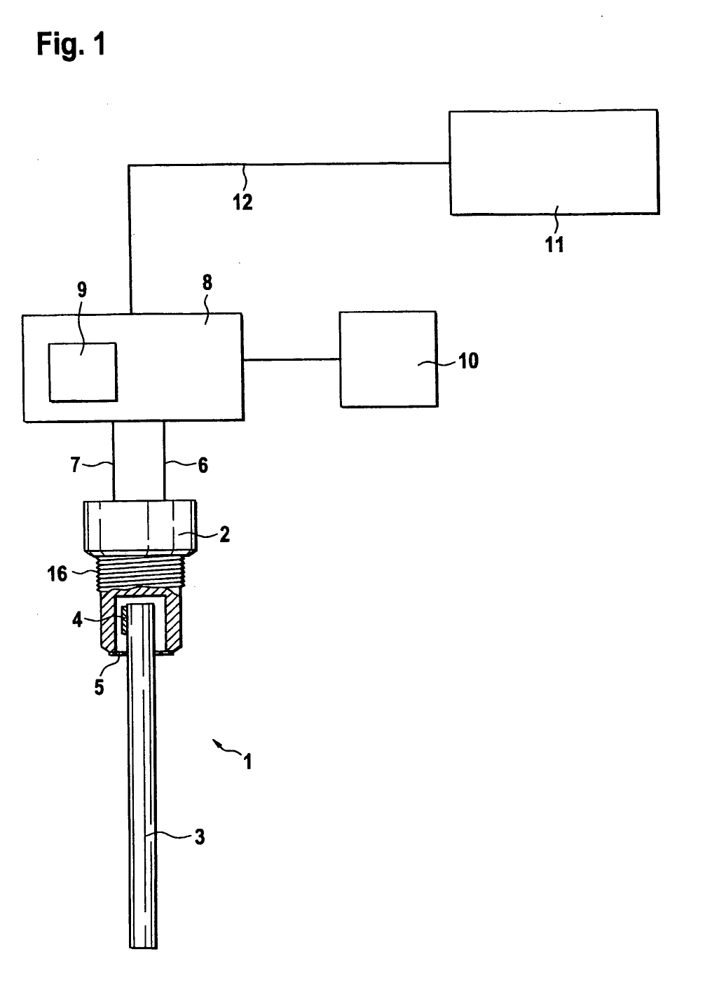

FIG. 1 shows a schematic illustration of the device according to the invention,

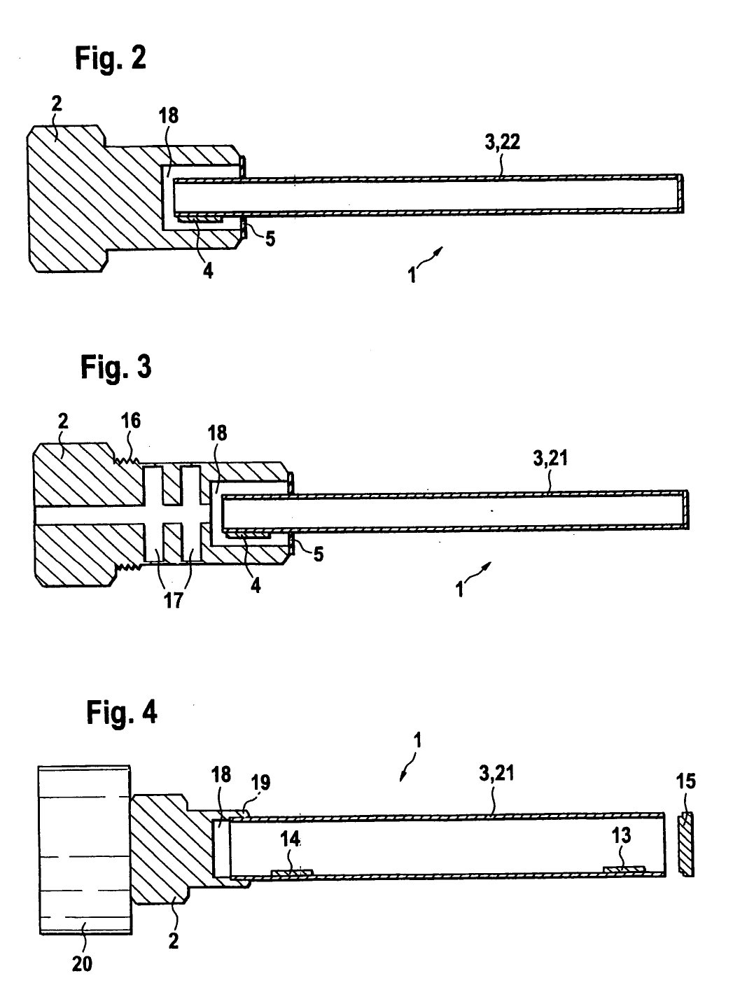

FIG. 2 shows a longitudinal section through a first embodiment of the device according to the invention,

FIG. 3 shows a longitudinal section through a second embodiment of the device according to the invention,

FIG. 4 shows a longitudinal section through a third embodiment of the device according to the invention and

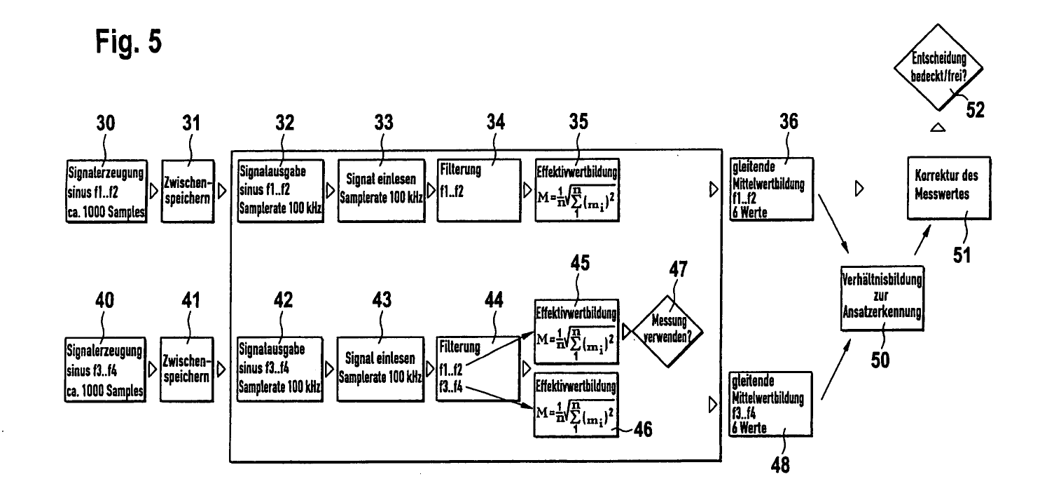

FIG. 5 shows a flow diagram relating to the evaluation of the measured data by the control/evaluation unit.

FIG. 1 shows schematic illustration of the device 1 according to the invention for determining and/or monitoring the level of a liquid or solid medium in a container—container and medium are, incidentally, not shown separately in FIG. 1. The container can be, for example a tank in which the medium is stored; of course, it can also be a tube through which a medium flows.

The vibration detector 1 according to the invention has a substantially cylindrical housing 20, on which a fixing part 2 is provided. The vibration detector 1 is positioned at a predetermined height in the container via the external thread 16 on the fixing part 2. The vibration detector 1 is preferably screwed into an appropriate opening in the container. It goes without saying that other types of fixing, for example by means of a flange can replace the screw fixing.

At one end of the housing 20 or the fixing part 2 of the vibration detector 1, the vibratory unit 3 is fitted. The vibratory unit 3 is either a tubular or rod-like structure. In the case shown, the vibratory unit 3 is spring-mounted on the housing 20 or the fixing part 2 via diaphragm 5, which is produced from steel, for example. By this means, good vibratory decoupling of the fixing part 2 or of the housing 20 from the vibrating tube 21 or the vibrating rod 22 is achieved. The spring-mass system comprising the relatively heavy fixing part 2 and the diaphragm 5 acts as an acoustic low-pass filter. In order to achieve effective decoupling, the resonant frequency of the spring-mass system must be tuned to be considerably below the excitation frequency of the vibratory unit 3. In addition, the diaphragm 5 prevents the filling material penetrating into the interior of the housing 20 of the vibration detector 1.

The vibratory unit 3 is excited, intermittently or continuously, into inherent vibrations in at least one mode by a drive/receiving unit 4. The drive/receiving unit 4 is preferably an electromechanical converter, especially a piezoelectric converter. In connection with the device of the invention, it is of course possible for other converter types to be used as well.

As already stated, the vibratory unit 3 is preferably excited into inherent vibrations in higher modes for the purpose of determining or monitoring a pre-determined level. It is possible both for an individual mode to be excited, for example by a sinusoidal signal, and also for a plurality of modes to be excited, for example by means of a noise signal or a sinusoidal sweep. At a defined time, the exciting signal is switched off; the subsequent decay signal of the vibratory unit 3 is then picked up by the same or a separate converter 4, 13, 14. In this case, use is made of the fact that contact between the vibratory unit 3 and the medium leads to increased friction losses, which manifests itself in a shortened decay time of the vibrations of the vibratory unit 3.

The electrical transmitted and received signals are routed between the control/evaluation unit 8 and the drive/receiving unit 4; 13, 14 via connecting lines 6, 7. The control/evaluation unit 8 is assigned a memory unit 11, in which measured data are, inter alia, buffered and desired values are stored. An evaluation algorithm makes it possible to detect process-induced and/or sensor-induced interference variables which distort the measured data. For example, one refinement of the device according to the invention provides for the formation of an attachment on the vibratory unit 3 to be detected and, if necessary, for a corrective influence to be exerted on the measured data. Measured data and error messages are transmitted to the operating personnel optically and/or acoustically via the output unit 10. In addition, the vibration detector 1 shown in FIG. 1 is connected to a remotely arranged monitoring or control station 11. The control/evaluation unit 8 and the control station 11 communicate with each other via the data line 12. The communication is preferably carried out on a digital basis, using one of the known communication protocols. The advantages of this type of data transmission lies in the increased immunity from interference.

FIG. 2 shows a longitudinal section of a first embodiment of the vibration detector 1 according to the invention. The vibratory unit 3 in the case shown is designed as a rod 22, which is preferably produced from steel or a hard plastic. The rod 22 reaches into a recess 18 in the fixing part 2 and is locked on the fixing part 2 by a diaphragm 55. The drive/receiving unit 4, designed as a piezoelectric converter, is arranged in that region of the rod 22 which extends into the recess 18 in the fixing part 2.

The rod 22 is excited into inherent vibrations in at least one mode via the piezoelectric converter 4. The response signals are picked up by the same piezoelectric converter 4 and forwarded to the control/evaluation unit 8 via signal lines, which are not shown separately in FIG. 2.

The fixing part 2 is screwed into an appropriate opening in the container via the external thread 16. In order to achieve the best possible vibratory decoupling between the fixing part 2 or the container and the vibrating rod 22, it is expedient to construct a spring-mass system comprising a heavy fastening part 2 and a diaphragm 5, preferable a metal diaphragm, which performs the function of an acoustic low-pass filter. In this way, the higher frequency components of interference frequencies, which are brought about, for example, in the bulk goods sector by conveyor belts or vibrators, are filtered out. In order to achieve effective decoupling from the container, the resonant frequency of the spring-mass system must be tuned to be considerably below the excitation frequencies of the rod 22. In addition, the diaphragm 5 also prevents contamination of the electromechanical converter 5, since it seals off the interior of the fixing part 2 with respect to the surroundings.

FIG. 3 shows a longitudinal section of a second embodiment of the vibration detector 1 according to the invention. This embodiment differs from that shown in FIG. 2 in two components: firstly, the vibratory unit 3 is a tube 21; secondly, the fixing part 2, in addition to the spring-mass system formed by the heavy fixing part 2 and diaphragm 5, is intrinsically springy. To this end, notches 17 are provided in the fixing part 2. These notches 17 run in such a way that ultimately only a relatively thin outer sleeve remains on the fixing part 2.

FIG. 4 reveals a longitudinal section of a third embodiment of the vibration detector 1 according to the invention. As in FIG. 3, the vibratory unit 3 is a tube 21. A first end region of the tube 21 projects into the recess 18 which is provided in the fixing part 2. In its first end region, the tube 21 is locked directly to the wall 19 of the fixing part 2.

The drive unit 13 and the receiving unit 14 are fastened to the inner wall of the tube 21. In order to prevent the possibility of filling material being deposited in the interior of the tube 21, the second end region of the tube 21 is closed off by a closing piece 15.

Decoupling from the container—if this is necessary—can be achieved, for example, by the insertion of an intermediate piece, not illustrated separately in FIG. 4. The intermediate piece should consist of a material whose acoustic input impedance differs considerably from the input impedance of the material from which the tube 21 is produced. As a rule, the intermediate piece will be produced from plastic if the tube 21 consists of a metal. Of course, the two aforementioned variants for decoupling the vibratory unit 3 from the container can also be employed in connection with the embodiment shown in FIG. 4.

FIG. 5 shows a flow diagram relating to the evaluation of the measured data by the control/evaluation unit 8. In the example shown, the control/evaluation unit 8 is capable of detecting both the influence of an attachment on the vibratory unit 3 and also of external vibrations. External vibrations are caused in the level detection sector by solid filling materials, for example by a conveyor belt on which the filling material is transported, or by filling material which comes briefly into contact with the vibration detector 1 during the filling of the container. If the influence of the process-induced and/or sensor-induced interfering variables is known, the level measurement data can be corrected. Consequently, the solution according to the invention permits the highly accurate and reliable determination of the level of a liquid or solid filling material which is stored in a container.

In connection with a development of the device according to the invention, it is viewed as a particularly prominent feature that both the signal generation and the measurement, the filtering and the assessment of the measured data are carried out in a computer (microprocessor). Therefore, only a minimum of analog technology is still needed. The manner in which the software which is used in the microprocessor operates in detail can be seen from FIG. 5 for a preferred configuration of the invention—as already stated. It should also be mentioned that the software solution can of course be replaced, at least partly, by appropriate analog technology.

The combination of the upper and lower part of the flow diagram illustrated in FIG. 5 is used for the detection of attachments; in the lower part, a description is additionally given of the possibility of detecting external vibrations.

As already mentioned, for example in order to detect the formation of an attachment on the vibratory unit 3, use is made of the fact that higher-frequency and lower-frequency modes are attenuated to different extents in the event of an attachment formation. For example, there are modes whose vibratory behavior is strongly influenced by the formation of an attachment, while in the case of other modes, no dependence or only a low dependence on the formation of an attachment or the mass change is manifested in the vibratory behavior.

In the program points 30, 40, for example in each case excitation signals in the form of a sinusoidal sweep in the frequency ranges f1 . . . f2, f3 . . . f4 are calculated.

The two frequency ranges are chosen such that the vibratory unit 3 is excited to vibrate in different modes. To reproduce the excitation signals, for example 1,000 digital values are determined in the two frequency ranges. These are buffered at 31, 41. At point 32, the digital values are converted into analog values; these analog values are fed at a predefined sample rate (e.g. 100 kHz) to the drive/receiving unit 4. The response signals supplied by the drive/receiving unit 4 are converted at 33, 43 into digital values at the same sample rate. At point 34, the signals which lie in the frequency f1 . . . f2 are filtered out. At program point 34, 44, the signals which lie in the excited frequency range f3 . . . f4 are filtered out. In addition, at 44 the signals which lie in the non-excited frequency range f1 . . . f2 are also filtered out.

The values obtained from the two frequency ranges f1 . . . f2, f3 . . . f4 at the program point 44 are used to determine whether external vibrations are distorting the level measured data. To this end, at 45, 46, the effective values of the signals filtered at 34, 44 are determined. External vibrations are then suspected if vibrations occur in the frequency range f1 . . . f2 which has not been excited. Depending on the intensity of the external vibrations, a decision is then made, at program point 47, as to whether the measured data can be used at all for the level measurement.

For the purpose of detecting attachments and preventing erroneous switching on the basis of brief covering, sliding averaging is carried at the program points 36, 48 by using a specific number of measured values (e.g. using six measured values) from the frequency ranges f1 . . . f2, f3 . . . f4. At 50, the ratio of the averages is formed. From the value determined at 50, it is possible to determine, qualitatively and/or quantitatively, whether or how much attachment has formed on the vibratory unit 3. The determined value is used to correct the level measured data (program point 51). By using the corrected measured value, at program point 52 a decision is then made as to whether the predetermined level in the container has been reached or not.

List of Designations

1 Vibration detector

2 Fixing part

3 Vibratory unit

4 Drive/receiving unit

5 Diaphragm

6 Connecting line

7 Connecting line

8 Control/evaluation unit

9 Memory unit

10 Indicating unit

11 Control station

12 Communication connection

13 Drive unit

14 Receiving unit

15 Closing piece

16 External thread

17 Notching

18 Recess

19 Tube wall

20 Housing

21 Tube

22 Rod

1. A device for determining and/or monitoring the level of a medium in a container, having a housing (20) to which at least one vibratory unit (3) is fixed,
having a drive/receiving unit (4; 13, 14) which is fixed directly to the vibratory unit (3) and excites it, at predefined time intervals or continuously, to vibrate in at least one of its inherent modes, and
having a control/evaluation unit (8) which uses the detected vibrations or the time change in the detected vibrations of the vibratory unit (3) to detect that the predetermined level has been reached, and/or uses the detected vibrations or the change in the detected vibrations to detect at least one sensor-induced and/or process-induced interference variable.

2. The device as claimed in claim 1, wherein the vibratory unit (3) is a rod (22) or a tube (21).

3. The device as claimed in claim 1 or 2, wherein a spring element (5; 2) is provided which is connected to the vibratory unit (3) in such a way that the latter is fixed in a sprung manner to the housing (20) or to a fixing part (2).

4. The device as claimed in claim 3, wherein the springy element is a diaphragm (5).

5. The device as claimed in claim 3, wherein the fixing part (2) is springy.

6. The device as claimed in claim 1, wherein the drive/receiving unit (4) is at least one electromechanical converter.

7. The device as claimed in claim 6, wherein the at least one drive/receiving unit (4; 13, 14) is fixed to the vibratory unit (3) in such a way that it does not come into direct contact with the medium.

8. The device as claimed in claim 2, 6 or 7, wherein the at least one drive/receiving unit (4; 13, 14) is arranged in the interior of the vibratory unit (3) or the vibratory tube (21).

9. The device as claimed in claim 2, 6 or 7, wherein the at least one drive/receiving unit is fixed to the outer face of the vibratory unit (3) in such a way that it is separated from the process or from the medium by the diaphragm (5) or a closing piece (15).

10. The device as claimed in claim 1 or 6, wherein the control/evaluation unit excites the vibratory unit to vibrate continuously via a first electromechanical or piezoelectric converter,
wherein a second electromechanical or piezo-electric converter receives the vibrations, and
wherein the control/evaluation unit uses the amplitude of or the amplitude change in the vibrations to detect that the predefined level has been reached.

11. The device as claimed in claim 1 or 6, wherein an electromechanical converter is used as the drive/receiving unit (4; 13, 14), and
wherein the control/evaluation unit (8) uses the input impedance of the coupled system comprising the vibratory unit (3) and electromechanical converter to detect that the predefined level has been reached.

12. The device as claimed in claim 1, or 6, wherein the control/evaluation unit (8) excites the vibratory unit (3) to vibrate for a predefined time interval via the drive/receiving unit (4; 13, 14),
wherein the control/evaluation unit (8) determines the decay response of the vibrations of the vibratory unit (3) or the time change in the vibration energy of the vibratory unit (3), and
wherein the control/evaluation unit (8) uses the decay response, especially the decay time of the vibrations or of the energy content of the decaying vibrations of the vibratory unit (3), or the time change in the vibration energy of the vibratory unit (3), to detect whether the vibratory unit (3) is vibrating freely or is in contact with the filling material, and/or
wherein the control/evaluation unit (8) uses the decay response or the time change in the vibration energy to detect whether at least one sensor-induced and/or process-induced interference variable is occurring.

13. The device as claimed in claim 1, 8, 9, 10 or 11, wherein control/evaluation unit (8) applies a periodic signal, a sweep signal or a noise signal to the drive/receiving unit (4; 13, 14).

14. The device as claimed in one or more of the preceding claims, wherein the drive/receiving unit (4; 13, 14) excites the vibratory unit (3) to vibrate in two mutually different modes, and
wherein the control/evaluation unit uses the vibratory behavior of the two modes to detect a sensor-induced and/or process-induced interference variable and, if necessary, to take it into account in determining the level.
